(19) United States
(12) Patent Application Publication
(10) Pub. No.: US 2010/0167711 A1
(43) Pub. Date: Jul. 1, 2010

(54) METHOD AND SYSTEM FOR CREATING COMMUNICATION GROUPS

(75) Inventors: RACHID M. ALAMEH, Crystal Lake, IL (US); THOMAS E. GITZINGER, Libertyville, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/346,145

(22) Filed: Dec. 30, 2008

(51) Int. Cl. H04M 3/42

(52) U.S. Cl. 455/416

(57) ABSTRACT

A method and system for creating a communication group (105). The method can include the steps of identifying (210) a plurality of mobile units (110) to be part of the communication group, initiating (220) a mating procedure between the mobile units to form the communication group in which confirmation of the mating procedure is executed by, at least in part, a secure identification process and enabling (230) the transfer of information between the mobile units of the communication group once the mating procedure is completed.

### BACKGROUND OF THE INVENTION

1. Field of the Invention

The claimed subject matter concerns the creation of communication groups and more particularly, the creation of such groups for the exchange of information between the groups.

2. Description of the Related Art

The proliferation of mobile communication units throughout society is well-documented. As an example, many parents now provide their children with mobile devices to enable the parents to stay in contact with them. As another example, an adult child of an elderly parent may give his/her parent a mobile unit for safety reasons. Even so, these two vulnerable sets of individuals may not have the full capability of responding to inquiries from a party concerned abut their welfare. Moreover, there is currently no easy and efficient way to ensure that any information to be shared between mobile units owned by individuals who are friends or family members is kept safe.

### SUMMARY OF THE INVENTION

A method and system for creating a communication group is described herein. The method can include the steps of identifying a plurality of mobile units to be part of the communication group, initiating a mating procedure between the mobile units to form the communication group in which confirmation of the mating procedure is executed by, at least in part, a secure identification process and enabling the transfer of information between the mobile units of the communication group once the mating procedure is completed.

The method may also include the step of sharing engagement rules between mobile units of the communication group following the initiation of the mating procedure. As an example, the engagement rules can outline procedures to be followed for the transfer of information between the mobile units of the communication group. The method may also include the step of selecting one of the mobile units of the communication group as a master unit and another mobile unit of the communication group as a slave unit. In this example, the master unit can control the type of information shared between the master unit and the slave unit via the engagement rules.

In one arrangement, the engagement rules outline procedures to be followed for the transfer of information between the master unit and the slave unit of the communication group by the master unit specifying in the engagement rules a transmit mode or one or more types of sensory information to be transferred from the slave unit to the master unit. The sensory information can include input captured by sensors at the slave unit. In another arrangement, the creation of the communication group can enable the master unit to access personal information from the slave unit.

In one embodiment, the secure identification process may include a biometric identification process in which a biometric characteristic can be matched at the mobile units to be part of the communication group. As an example, the biometric characteristic can be a fingerprint, a facial image, a voice sample or an ocular-based scan. In another embodiment, the secure identification process can be the entry of an authorized pass code or execution of an authorized and predefined movement.

The secure identification process can be conducted on each mobile unit that is to be part of the communication group. Also, conducting the secure identification process on each mobile unit that is to be part of the communication group can be performed in a synchronous or sequential fashion.

Another method of creating a secure communication group is described herein. The method can include the steps of selecting a plurality of mobile units to form the secure communication group—in which one of the mobile units will be a master unit and the remaining mobile units will be slave units—and conducting an authorization process between the selected mobile units in which an operator of the master unit provides unique information to each of the selected mobile units to confirm the creation of the secure communication group. The method can also include the step of enabling the master unit to receive sensory information and personal information from any of the slave units once the authorization process is completed.

A secure communication group is also described herein. The secure communication group can include a plurality of mobile units in which each mobile unit includes a transceiver for exchanging signals with the other mobile units of the secure communication group and a secure identification module for receiving unique identification information for confirming the inclusion of the mobile unit into the secure communication group. Each mobile unit may also include a processor in which the processor is operable to enable the transfer of information between the mobile unit and other mobile units that make up the secure communication group once the unique identification information is received. Each mobile unit of the secure communication group can receive engagement rules that set guidelines for the transfer of information between the mobile units of the secure communication group.

In one arrangement, one of the mobile units of the secure communication group can be a master unit and the remaining mobile units of the secure communication group can be slave units. The master unit can control the transfer of information between the master unit and the slave units through the engagement rules. For example, the master unit can control the transfer of information between the master unit and the slave unit by specifying a transmit mode or one or more types of sensory information to be collected at the slave unit and transferred to the master unit.

In one arrangement, the slave unit can include one or more of the following: a camera, a proximity sensor, a compass, a thermometer, a light detector, an altimeter, a global positioning system module, an accelerometer, a physiological monitoring unit or a microphone. The creation of the secure communication group can enable the master unit to access personal information from the slave unit. As an example, the secure identification module may rely on biometric characteristics, authorized pass codes or predefined movements to confirm the inclusion of the mobile unit into the secure communication group. As another example, the biometric characteristic can be a fingerprint, a facial image, a voice sample or an ocular-based scan.

### BRIEF DESCRIPTION OF THE DRAWINGS

Features that are believed to be novel are set forth with particularity in the appended claims. The claimed subject matter may best be understood by reference to the following description, taken in conjunction with the accompanying drawings, in the several figures of which like reference numerals identify like elements, and in which:

FIG. 1 illustrates an example of a secure communication group and a block diagram of a mobile unit; and

FIG. 2 shows an example of a method for creating a secure communication group.

### DETAILED DESCRIPTION

As required, detailed embodiments of the claimed subject matter are disclosed herein; however, it is to be understood that the disclosed embodiments are merely exemplary and can be embodied in various forms. Therefore, specific structural and functional details disclosed herein are not to be interpreted as limiting, but merely as a basis for the claims and as a representative basis for teaching one skilled in the art to variously employ the claimed subject matter in virtually any appropriately detailed structure. Further, the terms and phrases used herein are not intended to be limiting but rather to provide an understandable description.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The terms “coupled” or “communicatively coupled” as used herein are defined as connected, although not necessarily directly, and not necessarily mechanically.

The term “transceiver” can be defined as any component or group of components that is capable of receiving and/or transmitting communications signals. The term “processor” can mean any component or group of components, including any suitable combination of hardware and software, that is capable of carrying out any of the processes described herein. The term “mobile unit” can mean any portable communication unit capable of at least receiving transmissions. The term “information” can mean any type of data, facts, intelligence or advice that is capable of being transmitted to a mobile unit. A “communication group” or a “secure communication group” can mean any group of mobile units in which inclusion into the group is limited to only those mobile units that meet a set of predefined criteria. The term “master unit” means any unit that maintains or exerts some control over the operations or functioning of another unit, while the term “slave unit” means any unit over which another unit may maintain or exert some control over its operations or functioning.

The subject matter in this document refers to a method and system for creating a communication group. In one arrangement, the method can include the steps of identifying a plurality of mobile units to be part of the communication group, initiating a mating procedure between the mobile units to form the communication group, in which confirmation of the mating procedure is executed by, at least in part, a secure identification process and enabling the transfer of information between the mobile units of the communication group once the mating procedure is completed. As such, mobile units in the communication group may exchange information safely and efficiently between one another, such as personal and confidential information or information that is collected by sensory devices of the mobile units.

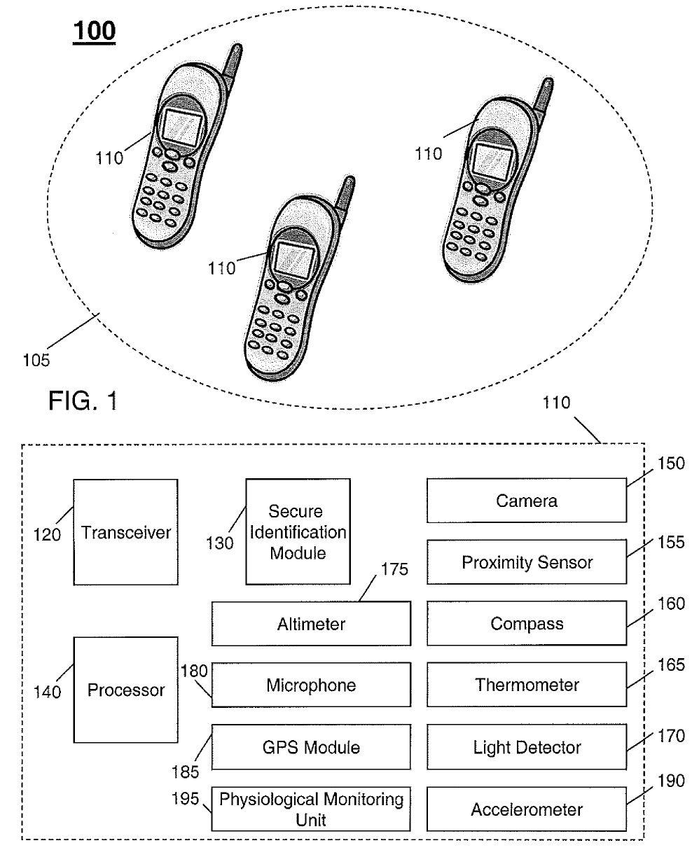

Referring to FIG. 1, a system 100 for creating a secure communication group 105 is shown. In one embodiment, the system 100 can include a plurality of mobile units 110, which are capable of exchanging communication signals between one another. These signals may be exchanged over various protocols, including those for wide area networks (WAN) or wireless local area networks (WLAN). Moreover, the mobile units 110 may communicate without the assistance of a network (i.e., two-way radios) or through short range protocols, like Bluetooth and ZigBee. As an example, the users or operators of these mobile units 110 may be related in some fashion, such as being friends, family members, co-workers or otherwise related with or involved in some common function or purpose.

A block diagram of a mobile unit 110 is also shown in FIG. 1. In this example, the mobile unit 110 may include a transceiver 120 for exchanging signals with the other mobile units 110 of the secure communication group 105. The mobile unit 110 may also include a secure identification module 130 that can receive unique identification information for confirming the inclusion of the mobile unit 110 into the secure communication group 105. A processor 140 may also be implemented into the mobile unit 110, which can enable the transfer of information between the mobile unit 110 and other mobile units 110 that make up the secure communication group 105 once the unique identification information is received. In one arrangement, the secure identification module 130 can include suitable software and circuitry that allow the module 130 to process and identify biometric characteristics, authorized pass codes or predefined movements that are captured by the mobile unit 110, as will be explained later.

As also pictured in FIG. 1, the mobile unit 110 may include a camera 150, a proximity sensor 155, a compass 160, a thermometer 165, a light detector 170 an altimeter 175, a microphone 180 and a GPS module 185. The mobile unit 110 may also include one or more accelerometers 190 and a physiological monitoring unit 195. As an example, the physiological monitoring unit 195 may monitor a person's heart rate or any other suitable physiological sign. The mobile unit 110 is not obligated to contain all these components, as the mobile unit 110 may include any suitable combination of these items. As an example, the camera 150 may be designed to capture various images and in particular, facial images for purposes of identifying a person. As another example, the proximity sensor 155 may be able to detect other mobile units 110 of the communication group 105 when those mobile units 110 are within a predetermined range of the mobile unit 110 containing the proximity sensor 155. For example, the proximity sensor 155 may contain software and circuitry for receiving and identifying identification and positional signals from other mobile units 110 in the group 105, which can permit the mobile unit 110 to pass on the identify and physical location of other mobile units 110 to the user of the mobile unit 110 having the proximity sensor 155.

The compass 160 can generate and provide information that shows the bearing of the mobile unit 110, and the thermometer 165 can provide temperature readings of various objects or environments, such as the temperature of the user of the mobile unit 110 or the temperature of the area in which the mobile unit 110 is positioned. The light detector 170 can determine the amount of ambient light in the environment of the mobile unit 110, and the altimeter 175 can determine the altitude of the mobile unit 110. As is known in the art, the microphone 180 can capture various audio signals, which can be processed for further input (as will be explained below), and the GPS module 185 can provide the location of the mobile unit 110. The accelerometer(s) 190 can monitor movement of the mobile unit 110, and the physiological monitoring unit 195 can monitor and measure various physiological signs of a user of the mobile unit 110. The information collected by these components can be sent to the processor 140, which can prepare this data for transmission to one or more other mobile units 110 in the communication group 105, as will be explained later. The above listing is not meant to be all-inclusive, as those skilled in the art will appreciate that the mobile unit 110 can be constructed to include other sensory devices.

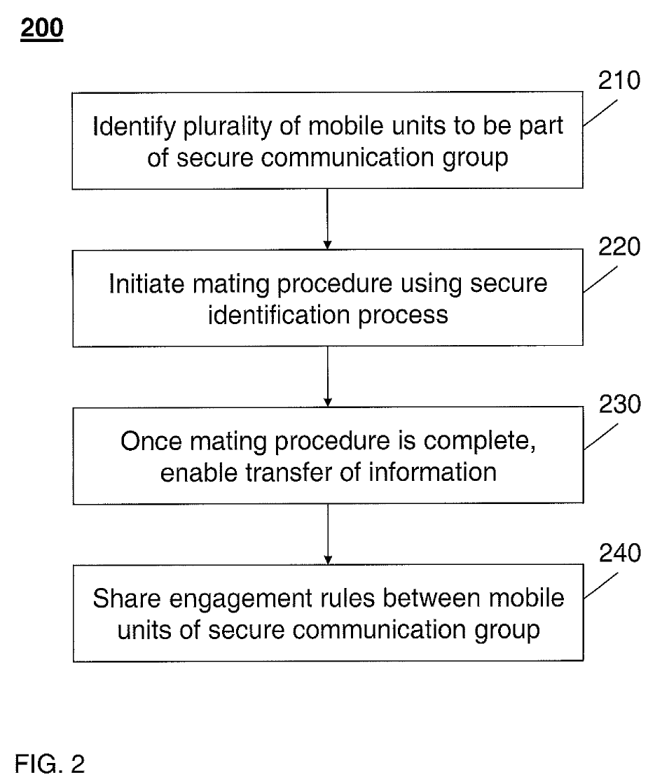

Turning to FIG. 2, a method 200 of providing information associated with a previously visited location is shown. To describe this method 200, reference will be made to FIG. 1, although it is understood that the method 200 can be practiced in any other suitable system using any other suitable components. Moreover, the steps of the method 200 are not limited to the particular order in which they are presented in the figure. Also, the method 200 can have a greater number of steps or a fewer number of steps than those shown in the figure.

At step 210, a plurality of mobile units to be part of a secure communication group can be identified, and at step 220, a mating procedure between the mobile units to form the communication group can be initiated in which confirmation of the mating procedure can be executed by—at least in part—a secure identification process. As shown at step 230, once the mating procedure is completed, the transfer of information between the mobile units of the communication group can be enabled. In addition, at step 240, engagement rules may be shared between mobile units of the communication group following the initiation of the mating procedure. If desired, one of the mobile units of the communication group can be selected as a master unit, and another mobile unit of the group may be selected as a slave unit.

As an example, one or more persons can identify a number of mobile units 110 that will be part of a secure communications group 105 to permit the transfer of information, particularly of a sensitive type, between the mobile units 110 of the group 105. As an example, a parent may wish to establish a communication group 105 between her mobile unit 110 and those of her children, or a supervisor may decide to include her mobile unit 110 and those of her employee-reports in a group 105.

Once identified, the user can initiate a mating procedure between the selected mobile units 110 to form the group 105. A “mating procedure” can be defined as any process in which a relationship is established between two or more mobile units for the purposed of sharing information between the mobile units. In one arrangement, the user can select an option from a menu of her mobile unit 110 and from menus of the other selected mobile units 110 to start the mating procedure. During this procedure, the selected mobile units 110 may communicate with one another over a network or through a simple short range wireless scheme to exchange identification information related to the mobile units 110 and any other suitable type of information.

As part of the mating procedure, a secure identification process may be conducted in which, for example, the mobile units 110 may request unique identification information from a user, which can be received and processed by the secure identification module 130. A “secure identification process” can be defined as any process in which the identity of a person is verified or confirmed through one or more predetermined tests. In addition, “unique identification information” means any type of information that is unique to a particular person or persons that can be used to establish the identity of that person or persons. As an example, the mobile unit 110 of the parent who wishes to establish the group 105 and the mobile units 110 of the children may request unique identification information from the parent. A “secure identification module” can mean any component that is capable of receiving and processing unique identification information for purposes of confirming a person's identity, and several examples will be presented below.

Continuing with the parent/child example, there are numerous ways in which the parent may provide this unique identification information. In one arrangement, the parent may provide a biometric measurement to the secure identification module 130 at her mobile unit 110 and the modules 130 of the mobile units 110 of her children. For example, the module 130 may be a fingerprint scanner, and the parent may have her fingerprint scanned at all the mobile units 110 that will form the group 105. The scanned image can then be compared with a pre-existing image to confirm her identity. As another example, the module 130 may be a voice recognition module (not shown) for confirming the identity of a speaker, and the parent may pronounce a phrase into each of the mobile units 110 that will form the communication group 105 for proper identification of the parent.

In another arrangement, the identification module 130 may be an image recognition engine that can receive images from the camera 150. As such, the parent may use the camera 150 to capture her image at each of the mobile units 110 that will be part of the communication group 105, and the image recognition engines can confirm the identity of the parent by comparing the recently taken image with that of file already stored in the mobile units 110. As another example, the module 130 may be an ocular-based scanner that may scan, for example, the retina or the iris of a person's eye. In this case, the ocular-based scanner of each mobile unit 110 that will form the communication group 105 may scan the eye(s) of the parent, which can be compared with pre-existing scans to correctly identify the parent. It must be stressed that the biometric characteristics listed above are not the only traits of a person that may be measured and analyzed to confirm that person's identity for purposes of forming a secure communication group 105. Those skilled in the art will appreciate that other biometric techniques may be employed here.

In addition, the secure identification module 130 is not limited to receiving and analyzing biometric characteristics to confirm identities. In one arrangement, the secure identification module 130 of each mobile unit 110 that will form the group 105 can receive an authorized pass code from the parent—whether input through a set of keys on the mobile units 110 or spoken through the microphone 180 of the mobile units 110—to confirm the identity of the parent. A “pass code” can be defined as any sequence or symbols or characters that are assigned to and are unique to one or more persons and can be subsequently used to identify that person or persons. In another arrangement, the secure identification module 130 can include one or more of the accelerometers 190, and the parent may move each of the mobile units 110 that will form the group 105 in a predefined manner. The accelerometers 190 can record the movements and can compare them to authorized movements that are stored in memory of the mobile units 110. If there is a match, then the identity of the parent may be confirmed.

In one embodiment, the secure identification process may be conducted on each of the mobile units 110 to form the secure communication group 105 in a synchronous or sequential fashion. For example, when executing biometric measurements, the user may simultaneously place her left index finger on a fingerprint scanner of a first mobile unit 110 and her right index finger on a scanner of a second mobile unit 110. Thus, these scans and analyses may occur at the same time. Alternatively, the user may place her left index finger on the scanner of a first mobile unit 11, followed by placing the same finger on the scanner of a second mobile unit 110. In this case, the scanning and analysis can be conducted sequentially.

It must be understood that the claimed subject matter is not limited to any of the above examples, as other suitable techniques may be used to confirm the identity of a person who wishes to set up a secure communication group 105. Moreover, it is important to note that the procedures presented here are not limited to parent/child relationships as used in the above examples, as other affiliations may be considered when forming a secure communication group 105.

Once the secure identification process is completed, the mobile units 110 that will form the secure communication group 105 can be mated. At this point, the mobile units 110 can form the communication group 105 and the transfer of information between the mobile units 110 can be enabled. As part of this process, engagement rules can be shared between the mobile units 110 of the group 105, and these engagement rules can outline procedures to be followed for the transfer of information between the units 110. An “engagement rule” can be defined as any rule or guideline that can be followed when making decisions or selections concerning the transfer of information. In one particular example, one or more of the mobile units 110 of the group 105 can be selected as a master unit, while one or more of the remaining units 110 can be selected as slave units. In this case, the master unit can control the type of information shared between the master unit and the slave unit via the engagement rules.

For example, referring once again to the parent/child relationship, a parent may select from a menu on her mobile unit 110 one or more rules that establish the type of information to be shared between her mobile unit 110 and that of her children's mobile units 110 of the group 105. These rules may also list the periodicity at which the shared information is to be passed between the mobile units 110 of the group 105 or may identify thresholds that when reached will cause the transfer of the information. The parent may also select her mobile unit 110 as a master unit of the secure communication group 105 and those of her children as slave units 110 of the group 105. As such, the parent's mobile unit 110 may control the type of information to be shared between the units 110 of the group 105.

For example, the parent, through the engagement rules, may specify a transmit mode to be used between the mobile units 110. The transmit mode may refer to the type of transport medium to use between the units 110 of the group 105, such as a short-range protocol like Bluetooth or a long-range system, like a cellular network. The parent may also specify certain types of sensory information to be transferred from a child's mobile unit 110 (i.e., slave unit) to the parent's mobile unit 110 (i.e., master unit). As an example, the parent may request that images captured by the camera 150 of the slave units send those images to the master unit on a streaming or periodic basis. As another example, the master unit can have the slave unit send to the master unit the slave unit's current location, acquired from the GPS module 185 of the slave unit, or the bearing or current heading of the slave unit, which can be obtained by the compass 160 of the slave unit.

Also, the master unit can request from the slave unit the temperature of the slave unit or the child holding the slave unit, as detected by the thermometer 165 of the slave unit, and the ambient or environmental lighting condition of the slave unit, as measured by the light detector 170 of the slave unit. The altimeter 175 of the slave unit can be used to obtain altitude readings of the slave unit, which may be requested by the master unit. Any audio picked up by the microphone 180 of the slave unit may also be sent to the master unit. Moreover, the proximity sensor 155 of the slave unit, when it detects the presence of the master unit, can provide proximity alerts or readings when instructed so by the master unit. The accelerometers 190 may detect a sudden drop of sharp movement of the slave unit, and the master unit can be notified of this event. As another example, the physiological monitoring unit 195 may measure any number of physiological signs of the user of the slave unit, and these signs may be communicated to the master unit. This type of information can be used by an operator of a master unit to maintain a careful watch over an operator of a slave unit.

Each of these sensors of the slave unit may provide the desired information to the master unit on a streaming or periodic basis at any suitable interval. As another example, when a threshold is reached at the slave unit, the master unit may be notified. As a specific example, if the slave unit moves into a certain area or outside a physical range, as measured by the GPS module 185, then the slave unit may inform the master unit of this occurrence. Of course, many other suitable thresholds are within the scope of the ideas described herein. Further, the sensory devices to be implemented in the mobile units 110 are not limited to the examples listed above. Additionally, the transfer of the sensory information is not limited to a unidirectional fashion from the slave unit to the master unit, as the mobile units 110 may transfer the information between one another in any suitable manner. In view of the creation of the secure communication group 105, a mobile unit 110, such as a master unit, may access personal information from another mobile unit 110, such as a slave unit. Personal information can mean any type of information that is not public knowledge, such as encrypted documents or any type of message received at or sent from a mobile unit.

While the various embodiments of the present invention have been illustrated and described, it will be clear that the claimed subject matter is not so limited. Numerous modifications, changes, variations, substitutions and equivalents will occur to those skilled in the art without departing from the spirit and scope of the present invention as defined by the appended claims.

What is claimed is:

1. A method of creating a communication group, comprising:
identifying a plurality of mobile units to be part of the communication group;
initiating a mating procedure between the mobile units to form the communication group, wherein confirmation of the mating procedure is executed by, at least in part, a secure identification process; and
enabling the transfer of information between the mobile units of the communication group once the mating procedure is completed.

2. The method according to claim 1, further comprising sharing engagement rules between mobile units of the communication group following the initiation of the mating procedure, wherein the engagement rules outline procedures to be followed for the transfer of information between the mobile units of the communication group.

3. The method according to claim 2, further comprising selecting one of the mobile units of the communication group as a master unit and another mobile unit of the communication group as a slave unit, wherein the master unit will control the type of information shared between the master unit and the slave unit via the engagement rules.

4. The method according to claim 3, wherein the engagement rules outline procedures to be followed for the transfer of information between the master unit and the slave unit of the communication group by the master unit specifying a transmit mode in the engagement rules.

5. The method according to claim 3, wherein the engagement rules outline procedures to be followed for the transfer of information between the mobile units of the communication group by the master unit specifying in the engagement rules one or more types of sensory information to be transferred from the slave unit to the master unit, wherein the sensory information includes input captured by sensors at the slave unit.

6. The method according to claim 3, wherein the creation of the communication group enables the master unit to access personal information from the slave unit.

7. The method according to claim 1, wherein the secure identification process includes a biometric identification process in which a biometric characteristic is matched at the mobile units to be part of the communication group.

8. The method according to claim 7, wherein the biometric characteristic is a fingerprint, a facial image, a voice sample or an ocular-based scan.

9. The method according to claim 1, wherein the secure identification process is the entry of an authorized pass code or execution of an authorized and predefined movement.

10. The method according to claim 1, wherein the secure identification process is conducted on each mobile unit that is to be part of the communication group.

11. The method according to claim 10, further comprising conducting the secure identification process on each mobile unit that is to be part of the communication group in a synchronous or sequential fashion.

12. A method of creating a secure communication group, comprising:
selecting a plurality of mobile units to form the secure communication group in which one of the mobile units will be a master unit and the remaining mobile units will be slave units;
conducting an authorization process between the selected mobile units in which an operator of the master unit provides unique information to each of the selected mobile units to confirm the creation of the secure communication group; and
once the authorization process is completed, enabling the master unit to receive sensory information and personal information from any of the slave units.

13. A secure communication group, comprising:
a plurality of mobile units, each mobile unit including:
a transceiver for exchanging signals with the other mobile units of the secure communication group;
a secure identification module for receiving unique identification information for confirming the inclusion of the mobile unit into the secure communication group; and
a processor, wherein the processor is operable to enable the transfer of information between the mobile unit and other mobile units that make up the secure communication group once the unique identification information is received.

14. The secure communication group according to claim 13, wherein each mobile unit of the secure communication group receives engagement rules that set guidelines for the transfer of information between the mobile units of the secure communication group.

15. The secure communication group according to claim 14, wherein one of the mobile units of the secure communication group is a master unit and the remaining mobile units of the secure communication group are slave units, wherein the master unit controls the transfer of information between the master unit and the slave units through the engagement rules.

16. The secure communication group according to claim 15, wherein the master unit controls the transfer of information between the master unit and the slave unit by specifying a transmit mode or one or more types of sensory information to be collected at the slave unit and transferred to the master unit.

17. The secure communication group according to claim 16, wherein the slave unit includes one or more of the following: a camera, a proximity sensor, a compass, a thermometer, a light detector, an altimeter, a global positioning system module, an accelerometer, a physiological monitoring unit or a microphone.

18. The secure communication group according to claim 15, wherein the creation of the secure communication group enables the master unit to access personal information from the slave unit

19. The secure communication group according to claim 13, wherein the secure identification module relies on biometric characteristics, authorized pass codes or predefined movements to confirm the inclusion of the mobile unit into the secure communication group.

20. The secure communication group according to claim 19, wherein the biometric characteristic is a fingerprint, a facial image, a voice sample or an ocular-based scan.
